(19) United States
(12) Patent Application Publication
(10) Pub. No.: US 2004/0008165 A1
(43) Pub. Date: Jan. 15, 2004

(54) Method that enables the organic light emitting diodes in a displayer to show multiple gray levels

(76) Inventor: Chen Yen-Hua, Taichung Hsien (TW)

Correspondence Address: BIRCH STEWART KOLASCH & BIRCH, PO BOX 747, FALLS CHURCH, VA, 22040-0747, US

(21) Appl. No.: 10/331,980

(22) Filed: Dec. 31, 2002

(30) Foreign Application Priority Data
Jul. 15, 2002 (TW) 091115683

(51) Int. Cl. G09G 3/30; G09G 3/32

(52) U.S. Cl. 345/76

(57) ABSTRACT

The invention provides a method that enables the organic light emitting diodes in a displayer to show multiple gray levels. The method is using power supply circuits, which are electrically connected to each data line in the displayer, to control each switch in the power supply circuits so as to provide a composite current to its connected data line in order to drive each organic light emitting diode. At this time, the organic light emitting diodes will show multiple gray levels due to different current values.

### FIELD OF THE INVENTION

The invention relates to a displaying technique of a displayer that has organic light emitting diodes and, more particularly, to a driving method that enables the organic light emitting diodes inside the displayer to have different gray levels.

### BACKGROUND OF THE INVENTION

There are two conventional driving methods that enable the organic light emitting diodes inside the displayer to have different gray levels. One is the pulse width modulation, and the other is the frame rate modulation.

The pulse width modulation is used to decide the illumination time of each organic light emitting diode so that each organic light emitting diode has different gray levels. Because the organic light emitting diode is directly driven by the current, the longer time it takes to illuminate the organic light emitting diode by the current, the brighter the organic light emitting diode will be. Conversely, the shorter time it takes to illuminate the organic light emitting diode, the dimmer the organic light emitting diode will be.

On the other hand, the frame rate modulation is used to decide the number of times that each organic light emitting diode is illuminated so that each organic light emitting diode has different gray levels. As mentioned above, the organic light emitting diode is directly driven by the current. Therefore, the more the current illuminates the organic light emitting diode, the longer the illumination time can be actually accumulated, which in turn can make the organic light emitting diode brighter. Conversely, the less the current illuminates the organic light emitting diode, the shorter the illumination time can be actually accumulated, which in turn can make the organic light emitting diode dimmer.

However, there is a characteristic shared by the above two conventional methods; that is, they all utilize scanning lines to divide the scanning time of the organic light emitting diodes. Then, by distributing the illumination time of each organic light emitting diode or by distributing the number of times that each organic light emitting diode is illuminated, the displayer can display multiple gray levels. Unfortunately, the characteristic is also a drawback of the conventional methods. The reason is that after the time division, every current in the small time segment becomes very small. As a result, the differences among the gray levels of each organic light emitting diode are not significant, which means that the brightness and contrast are not good enough. Consequently, the effect of showing many kinds of gray levels cannot be achieved.

In addition, the division of the scanning time is performed by increasing the frequency of the organic light emitting diode driven by the data lines. However, to increase the frequency can cause high electricity consumption; therefore, the RC effect of the displayer will become more significant. As a result, uneven brightness and cross talk are prone to be generated. Moreover, in spite of that an even brightness is given, a strong momentarily brightness caused by the scanning time division means that the momentarily voltage and current will be relatively increased; therefore, the electricity consumption will be increased as well.

### SUMMARY OF THE INVENTION

The object of the invention is to solve the problems of the conventional techniques. The problems include that the displayer cannot show multiple gray levels and that the contrast between the gray levels is not good enough.

In order to achieve the above object, the invention provides a method that enables the displayer with the organic light emitting diodes to show multiple gray levels. The method includes that each data line is separately connected to a power supply circuit, wherein each power supply circuit is composed of a plurality of switches and a plurality of circuits of current source, in which each switch is electrically connected to a circuit of current source in series, whereas the connections among the series connections are in parallel; and that each scanning made by each of the scanning lines is well performed and each switch in each power supply circuit is well controlled so that a composite current can be provided to its connected data line to drive each organic light emitting diode.

The objects and technical contents of the invention will be better understood by those who are skilled in the art through the description of the following embodiments with reference to the drawings.

### BRIEF DESCRIPTION OF THE DRAWINGS

FIG. 1A is a schematic diagram showing an embodiment of the invention.

FIG. 1B is to show the values of various composite currents that may be provided by the power supply circuits shown in FIG. 1.

FIG. 2 is to show various composite currents that may be provided by the power supply circuits according to an embodiment of the invention.

### DESCRIPTION OF THE PREFERRED EMBODIMENTS

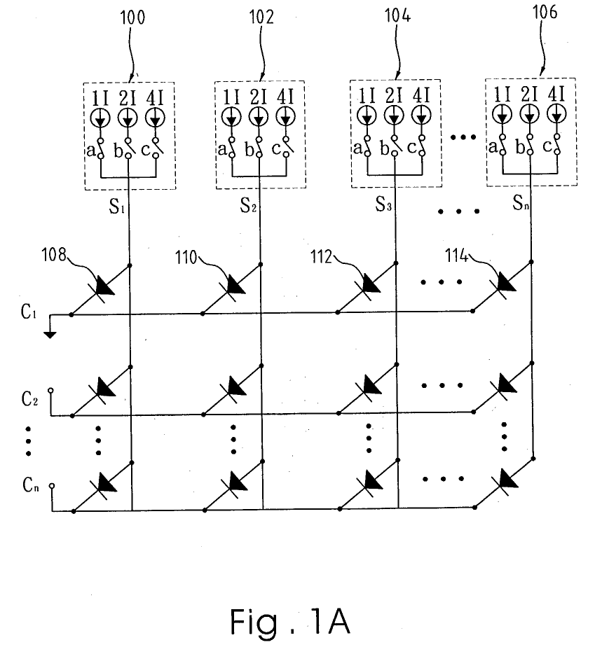

FIG. 1A is a schematic diagram showing an embodiment of the invention. As shown in FIG. 1, the displayer has a plurality of scanning lines C1 to Cn, a plurality of data lines S1 to Sn, and a plurality of organic light emitting diodes that are driven by the scanning lines and the data lines. In addition, the power supply circuits 100, 102, 104, and 106 required by the method of the invention are provided in multiple quantities. The connections among the circuits are that each switch is electrically connected to a circuit of current source in series and that the connections among the series connections are in parallel. Moreover, each of the power supply circuits 100, 102, 104, and 106 is connected to each of the data lines S1, S2, S3, and Sn respectively to function as a main power for driving the organic light emitting diodes.

The power supply circuits 100, 102, 104, and 106 shown in FIG. 1A contain current sources 1I, 2I, and 4I of different currents, wherein the I represents a unit of current. The magnitude of the unit of current is decided by the designer. In the embodiment of the invention, the magnitude of each current is designed by adopting a power of 2 so that each value of the magnitude can comply with the hardware design for easy to be accessed and implemented. However, the magnitude and the quantity of the current source are not limited by the embodiment. Likewise, the quantity of the switches a, b, and c that are contained in the power supply circuits 100, 102, 104, and 106 is not limited by the embodiment, either.

According to the method of the invention, each scanning made by each of the scanning lines is well performed and each switch in each power supply circuit is well controlled so that a composite current can be provided to its connected data line to drive each organic light emitting diode. With reference to FIG. 1A, the scanning line C1 is making a scan; meanwhile, the switch a that controls the power supply circuit 100 is on, whereas the switches b and c are off; the switches a and b that control the power supply circuit 102 are on, whereas the switch c is off; the switches a and c that control the power supply circuit 104 are on, whereas the switch b is off; and the switches a, b, and c that control the power supply circuit 106 are all on. Therefore, the power supply circuits 100, 102, 104, and 106 are providing the currents 1I, 3I, 5I, and 7I respectively. Hence, the organic light emitting diodes 108, 110, 112, and 114 are driven by the above currents to show different gray levels. FIG. 1B further shows the values of various composite currents that may be provided by the power supply circuits shown in FIG. 1A.

Another embodiment of the invention is to apply the foregoing principles of the modulations of the conventional techniques, and the application enables the current source with a fixed quantity to generate more composite current values so that the organic light emitting diodes can show more different kinds of gray levels. When the pulse width modulation is applied, the following procedures will be performed: first, each scanning made by each of the scanning lines is well performed; second, the conducting time of each switch in each of the power supply circuits is well controlled; and finally, a composite current can be provided to its connected data line to drive each organic light emitting diode, wherein the conducting time is not longer than the scanning time of the scanning lines. On the other hand, when the frame rate modulation is applied, the following procedures will be performed: first, each scanning made by each of the scanning lines is well performed; second, the number of times of conduction made by each switch in each of the power supply circuits is controlled, and the control is made within the scanning time of the scanning lines; and finally, a composite current can be provided to its connected data line to drive each organic light emitting diode.

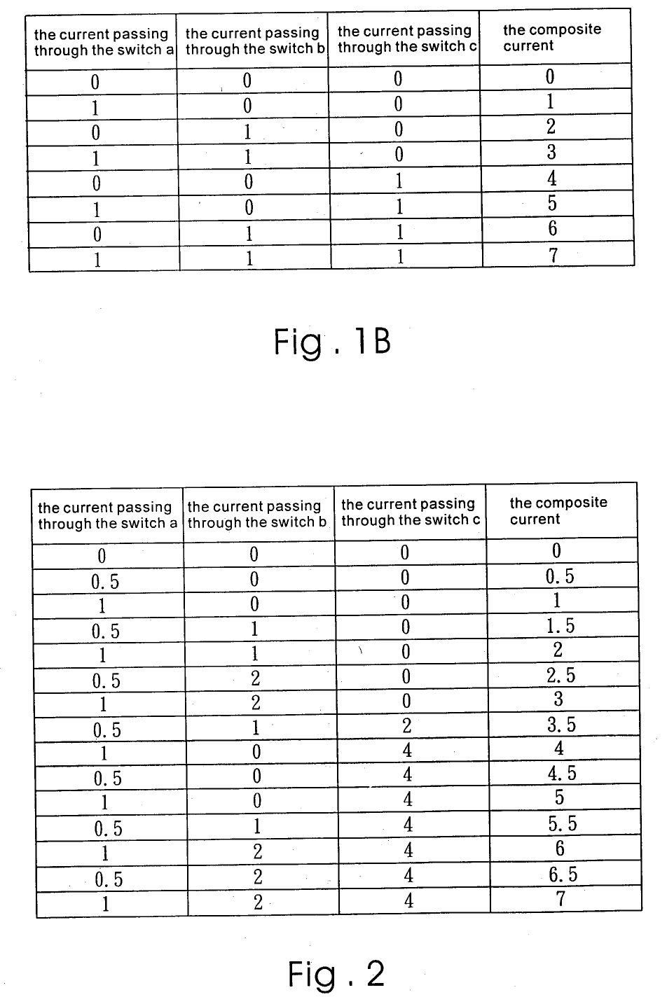

FIG. 2 is to show various composite currents that may be provided by the power supply circuits when the invention applies two conventional techniques.

The features of the invention are concluded as below:

1. The invention does not require high driving frequency; therefore, the RC effect can be avoided and cross talk will not be generated.

2. The ability of displaying the contrast on the displayer can be enhanced effectively.

3. The electricity consumption is low.

4. Higher values of gray levels can be provided to the organic light emitting diodes by increasing the quantity of the current source.

5. The principles of the modulations of the conventional techniques can be applied so that the current source with a fixed quantity can generate more composite current values, which in turn enables the organic light emitting diodes to show more different kinds of gray levels.

The specific embodiments above are only intended to illustrate the invention; they do not, however, to limit the invention to the specific embodiments. Accordingly, those who are skilled in the art can make various modifications and changes without departing from the spirit and scope of the invention as described in the appended claims.

What is claimed is:

1. A method that enables the organic light emitting diodes in a displayer to show multiple gray levels, wherein
the displayer has a plurality of scanning lines, a plurality of data lines, and a plurality of organic light emitting diodes driven by the scanning lines and the data lines; the method including the following steps:
(a) each data line is separately connected to a power supply circuit, wherein each switch is electrically connected to a circuit of current source in series, whereas the connections among the series connections are in parallel;
(b) each scanning made by each of the scanning lines is well performed and each switch in each power supply circuit is well controlled so that a composite current can be provided to its connected data line to drive each organic light emitting diode.

2. The method that enables the organic light emitting diodes in a displayer to show multiple gray levels as claimed in claim 1, wherein the magnitude of the ith current source in the power supply circuit is 2ⁱ⁻¹ units of current.

3. A method that enables the organic light emitting diodes in a displayer to show multiple gray levels, wherein
the displayer has a plurality of scanning lines, a plurality of data lines, and a plurality of organic light emitting diodes driven by the scanning lines and the data lines, wherein each scanning line scans the organic light emitting diode by a scanning time; the method including the following steps:
(a) each data line is separately connected to a power supply circuit, wherein each switch is electrically connected to a circuit of current source in series, whereas the connections among the series connections are in parallel;
(b) each scanning made by each of the scanning lines is well performed and the conducting time of each switch in each of the power supply circuits is well controlled so that a composite current can be provided to its connected data line to drive each organic light emitting diode, wherein the conducting time is not longer than the scanning time.

4. The method that enables the organic light emitting diodes in a displayer to show multiple gray levels as claimed in claim 3, wherein the magnitude of the ith current source in the power supply circuit is 2^{i -1} units of current.

5. A method that enables the organic light emitting diodes in a displayer to show multiple gray levels, wherein
the displayer has a plurality of scanning lines, a plurality of data lines, and a plurality of organic light emitting diodes driven by the scanning lines and the data lines, wherein each scanning line scans the organic light emitting diode by a scanning time; the method including the following steps:
(a) each data line is separately connected to a power supply circuit, wherein each switch is electrically connected to a circuit of current source in series, whereas the connections among the series connections are in parallel;
(b) each scanning made by each of the scanning lines is well performed and the number of times of conducting each switch in each of the power supply circuits is well controlled within the scanning time so that a composite current can be provided to its connected data line to drive each organic light emitting diode.

6. The method that enables the organic light emitting diodes in a displayer to show multiple gray levels as claimed in claim 5, wherein the magnitude of the ith current source in the power supply circuit is 2ⁱ⁻¹ units of current.
